(19) United States
(12) Patent Application Publication
(10) Pub. No.: US 2022/0078784 A1
(43) Pub. Date: Mar. 10, 2022

(54) Method and Controller Node for Determining a Network Parameter

(71) Applicant: Telefonaktiebolaget LM Ericsson (publ), Stockholm (SE)

(72) Inventors: Vijaya Yajnanarayana, Bangalore (IN); Ankit Jauhari, Bangalore (IN); Ramamurthy Badrinath, Bangalore (IN); Anand Varadarajan, Chennai (IN); N Hari Kumar, Chennai (IN)

(21) Appl. No.: 17/419,372

(22) PCT Filed: Jan. 9, 2019
(86) PCT No.: PCT/IN2019/050015

§ 371 Date: Jun. 29, 2021

(51) Int. Cl. H04W 72/04

(52) U.S. Cl. CPC H04W 72/048

(57) ABSTRACT

A controller node (18) and method for determining a network parameter are provided. The controller node (18) determines (S240) type information associated with wireless devices which are connected to a radio network node. The controller node (18) further determines (S250) the network parameter based on the type information.

### TECHNICAL FIELD

Embodiments herein relate to a method and controller node in a wireless communication network. Furthermore, a computer program product and a computer readable storage medium are also provided herein. In particular, embodiments herein relate to determining or optimizing a network parameter.

### BACKGROUND

In a typical wireless communication network, wireless devices, also known as wireless communication devices, mobile stations, stations (STA) and/or user equipments (UE), communicate via a Radio Access Network (RAN) to one or more core networks (CNs). The RAN covers a geographical area which is divided into service areas or cells, with each service area or cell being served by a radio network node such as a radio access node, e.g. a Wi-Fi access point or a radio base station (RBS), which in some networks may also be denoted, for example, a NodeB (NB), an enhanced NodeB (eNodeB), or a gNodeB (gNB). The service area or cell provided by the radio network node 12 is also referred to as a wireless coverage or radio coverage. The radio network node communicates over an air interface operating on radio frequencies with the wireless device within the service area or cell.

A Universal Mobile Telecommunications System (UMTS) is a third generation (3G) telecommunication network, which evolved from the second generation (2G) Global System for Mobile Communications (GSM). The UMTS terrestrial radio access network (UTRAN) is essentially a RAN using wideband code division multiple access (WCDMA) and/or High Speed Packet Access (HSPA) for wireless devices. In a forum known as the Third Generation Partnership Project (3GPP), telecommunications suppliers propose and agree upon standards for third generation networks, and investigate enhanced data rate and radio capacity. In some RANs, e.g. as in UTRAN, several radio network nodes may be connected, e.g. by landlines or microwave, to a controller node, such as a radio network controller node (RNC) or a base station controller node (BSC), which supervises and coordinates various activities of the plural radio network nodes connected thereto. This type of connection is sometimes referred to as a backhaul connection. The RNCs and BSCs are typically connected to one or more core networks.

Specifications for the Evolved Packet System (EPS), also called a Fourth Generation (4G) network, have been completed within the 3^{rd} Generation Partnership Project (3GPP) and this work continues in the coming 3GPP releases, for example to specify a Fifth Generation (5G) network such as the new generation radio (NR). The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs. In general, in E-UTRAN/LTE the functions of an RNC are distributed between the radio network nodes, e.g. eNodeBs in LTE, and the core network. As such, the RAN of an EPS has an essentially “flat” architecture comprising radio network nodes connected directly to one or more core networks, i.e., they are not connected to RNCs. To compensate for that, the E-UTRAN specification defines a direct interface between the radio network nodes, this interface being denoted as X2 interface. Additionally, 3GPP has specified two different air interfaces supporting for machine type communications (MTC), e.g., Internet of Things (IoT), drones and vehicular.

The evolution of wireless communication network from 2^{nd} generation (2G) to 5G has seen a consistent shift from a wireless communication network dominated by wireless devices, e.g., mobile station type devices, to a wireless communication network where in a significant ratio of wireless devices are of other types, e.g., machine type devices. Many of these other types wireless devices use a same subscriber identification module (SIM) and radio resource controller node (RRC) signaling as the mobile station type devices, however, they generate vastly different traffic and interference patterns. Existing wireless communication networks are optimal for terrestrial deployment of mobile station type devices. The machines type devices can however have varying characteristics including higher altitude such as drones, higher speed e.g., vehicles, low-power e.g., internet of things (IoT) devices, etc.

There is therefore a need in the wireless communication network to achieve optimal performance when wireless devices in various types are connected.

### SUMMARY

An object of embodiments herein is to provide a mechanism for improving performance of the wireless communication network, particularly to provide a method and controller node for determining a network parameter in order to improve performance in terms of throughput, coverage, capacity and/or interference.

According to an aspect the object is achieved by providing a method performed by a controller node. The controller node determines type information associated with wireless devices which are connected to a radio network node. The controller node further determines a network parameter based on the type information. A type of a wireless device may be classified based on a type of communication, velocity, movement, data capacity or similar.

According to still another aspect the object is achieved by providing a controller node. The controller node is configured to determine type information associated with wireless devices which are connected to a radio network node; and determine a network parameter based on the type information.

It is furthermore provided herein a computer program product comprising instructions, which, when executed on at least one processor, cause the at least one processor to carry out any of the methods above, as performed by the controller node. It is additionally provided herein a computer-readable storage medium, having stored thereon a computer program product comprising instructions which, when executed on at least one processor, cause the at least one processor to carry out the method according to any of the methods above, as performed by the controller node.

By determining the network parameter based on the type information, the embodiments herein will improve overall network performance such as the throughput, coverage, capacity and/or interference etc. For example, if there are more aerial type wireless devices connected to the radio network node, an antenna tilt angle as an example of the network parameter would be reduced, thereby the aerial type wireless devices will be served optimally, throughput etc. will be improved accordingly.

### BRIEF DESCRIPTION OF THE DRAWINGS

Embodiments will now be described in more detail in relation to the enclosed drawings, in which:

FIG. 1 is a schematic overview depicting a wireless communication network according to embodiments herein;

FIG. 2a is a flowchart depicting methods performed by a controller node according to embodiments herein;

FIG. 2b illustrates examples features extracted from wireless devices according to embodiments herein;

FIG. 3 is a block diagram depicting a controller node according to embodiments herein;

FIG. 4 schematically illustrates a telecommunication network connected via an intermediate network to a host computer;

FIG. 5 is a generalized block diagram of a host computer communicating via a base station with a user equipment over a partially wireless connection;

FIG. 6-FIG. 9 are flowcharts illustrating methods implemented in a communication system including a host computer, a base station and a user equipment.

### DETAILED DESCRIPTION

As part of developing embodiments herein, a problem will first be identified and shortly discussed.

Conventional wireless communication networks are optimized for mobile station type devices communication. For instance, an antenna configuration as an example of a network parameter, an antenna tilt angle of a radio network node, e.g., base station, is optimized to serve terrestrial mobile stations and may not aid certain machine type devices like drones, which are at higher altitude and require a different antenna tilt angle to serve optimally. Another example of network parameter is power related parameters. Power related parameters which are optimized for terrestrial based mobile stations may not be optimal for machine type devices as well. For example, with having 33% drones in the wireless communication network, the interference over thermal characteristics increases significantly compared to an only terrestrial mobile station deployment.

Some solutions were proposed to control this increased interference by tuning the power control parameters for all wireless devices. Some other solutions employ similar strategy, but with maximizing a lifetime of the machine type devices, e.g., machine to machine (M2M) devices, as the objective.

However all conventional solutions do not consider the type information of wireless devices connected in the radio network node. The conventional solutions are sub-optimal for future wireless communication network, e.g., 5G, where wireless devices in various different types are connected to the radio network node. A type of the wireless device may indicate a type of communication; velocity, movement, data capacity or similar of the wireless device 10. For instance, the wireless devices may be classified into aerial type e.g., a drone, and territorial type such as land vehicles. More examples of the various different types will be provided below.

For instance, in a home automation scenario, there will be a lot of machine type devices, e.g., IoT devices, connected to a wireless communication network, apart from mobile station type devices. Also, the usages of these machine type devices would be different at different times. There also exists a clear trend in the traffic generated by these machine type devices. For example, some machine type devices, involved in home automation like a blender, a geyser appliance, a microwave, a coffee machine, etc., generate dynamic traffic in the mornings and in the evenings when the home is fully occupied. For these machine type devices to work seamlessly, it is important that the network parameters are configured appropriately to efficiently utilize the wireless communication network.

Thus there is a need in wireless communication network to achieve optimal performance in terms of throughput, coverage, capacity and/or interference in an ever-changing environment.

In order to achieve optimal performance in terms of throughput, coverage, capacity and/or interference it is proposed herein to determine the network parameters such as antenna parameters such as the antenna tilt angle, power control parameters such as an open loop power control parameter, etc. based on the type information of connected wireless devices. The type information may e.g., be ratios of different types of wireless devices connected to the wireless communication network.

It is noted that determining the network parameter refers to determining a value of the network parameter, which may also be called optimizing, tuning or adapting the network parameter with reference to an existing value of the network parameter.

Based on the type information of connected wireless devices, the network parameters will be optimized to serve certain objectives, such as improving throughput etc. For example, if there are more aerial type devices than regular ground mobile devices such as cars then the antenna tilt angle can be reduced, i.e. the antenna tilt may allow the antenna to cover a more elevated space. Therefore, the overall throughput and Signal to Interference plus Noise Ratio (SINR) may be improved by using the proposed embodiments herein.

Additionally, the ratios of device types may constantly be changing since wireless devices may enter and leave the wireless communication network dynamically, thereby rendering a terrestrial mobile station optimized network even more inefficient for wireless devices of various types. It may be herein further proposed to dynamically classify wireless devices into different types periodically and/or upon a triggering event, and/or by using a machine learning algorithm.

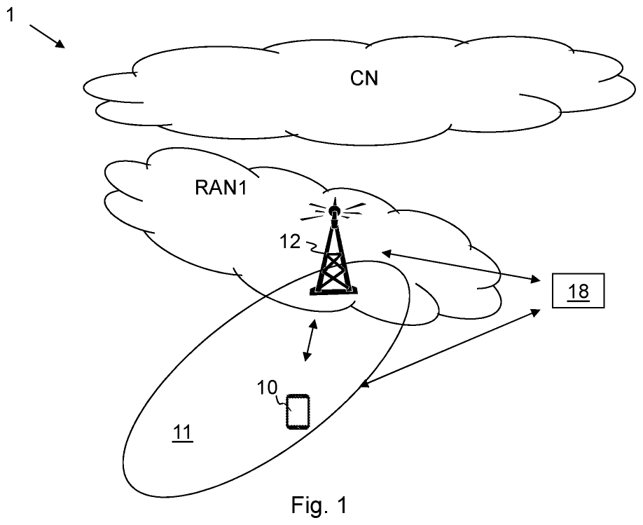

FIG. 1 is a schematic overview depicting a wireless communication network 1 comprising one or more RANs, e.g. a first RAN (RANI), connected to one or more CNs, e.g. a 5G core network (5GCs). The wireless communication network 1 may use one or more technologies, such as Wi-Fi, Long Term Evolution (LTE), LTE-Advanced, New Radio (NR), Wideband Code Division Multiple Access (WCDMA), Global System for Mobile communications/Enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in, e.g., a LTE or a NR context, however, embodiments are applicable also in further development of the existing communication systems such as e.g. GSM or UMTS.

In the wireless communication network 1, wireless devices, e.g. a wireless device 10 such as a mobile station, a non-access point (non-AP) station (STA), a STA, a user equipment (UE) and/or a wireless terminal, are connected via the one or more RANs, to the one or more CNs, e.g. 5GCs. It should be understood by those skilled in the art that “wireless device” is a non-limiting term which means any terminal, wireless communication terminal, communication equipment, machine type communication (MTC) device, device to device (D2D) terminal, IoT operable device, or user equipment e.g. smart phone, laptop, mobile phone, sensor, relay, mobile tablets or any device communicating within a cell or service area. Though only one wireless device 10 is shown in FIG. 1, the skilled person will appreciate that the embodiments here are also applicable to multiple wireless devices.

The wireless communication network 1 comprises a radio network node 12. The radio network node 12 is exemplified herein as a RAN node providing radio coverage over a geographical area, a service area 11, of a radio access technology (RAT), such as NR, LTE, UMTS, Wi-Fi or similar. The radio network node 12 may be a radio access network node such as an access point, e.g. a wireless local area network (WLAN) access point or an Access Point Station (AP STA), an access controller node. Examples of the radio network node 12 may also be a NodeB, a gNodeB, an evolved Node B (eNB, eNodeB), a base transceiver station, Access Point Base Station, base station router, a transmission arrangement of a radio network node, a stand-alone access point or any other network unit capable of serving a wireless device 10 within the service area served by the radio network node 12 depending e.g. on the radio access technology and terminology used and may be denoted as a receiving radio network node.

The wireless communication network 1 also comprises a controller node 18 which determines one or more network parameters as described below. The controller node 18 may be implemented either as a distributed node or a stand-alone node. As a stand-alone node, the controller node 18 may be a controller node server or the controller node 18 may be collocated with the radio network node 12. Alternatively, when in form of a distributed node different modules or functions of the controller node 18 may be distributed at different locations, e.g. over different physical devices or servers, or in a cloud, where necessary.

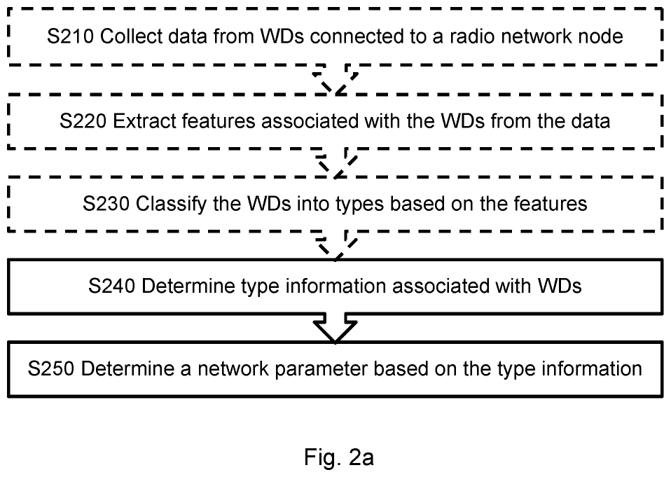

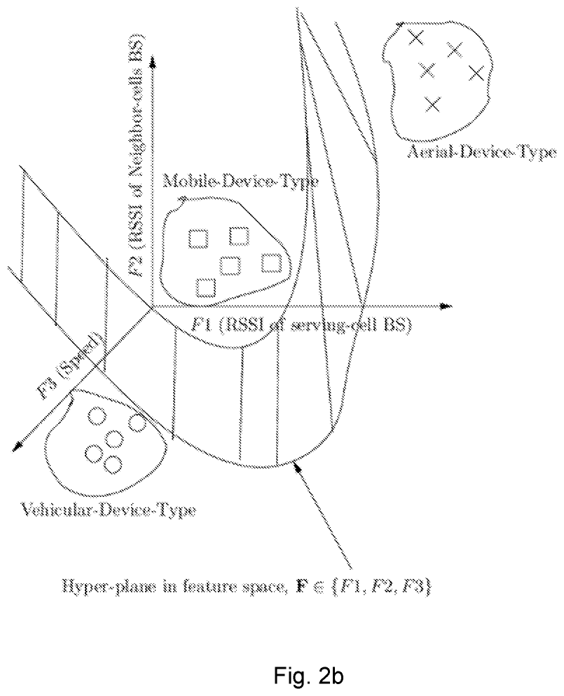

FIG. 2a is a flowchart describing an exemplary method performed by a controller node 18, e.g., for determining a network parameter. The following actions may be taken in any suitable order. Actions that could be performed only in some embodiments may be marked with dashed boxes.

Action S210. In order to determine the network parameter, the controller node 18 may start by collecting data from wireless devices which wireless devices are connected to the radio network node 12.

The collected data may comprise control data from the connected wireless devices such as measurement reports on preambles, channels, beams, etc. It can also comprise user data e.g. transmitted on the traffic carrying channels.

The controller node 18 may collect the data via the measurement reports and/or the received user data.

Action S220. The controller node 18 may then extract one or more features associated with the wireless devices from the collected data.

The one or more features (F) may be indicated by a mobility speed of the wireless device, a signal quality, e.g., a signal quality from the wireless device 10 to the radio network node 12 or a signal quality from the wireless device 10 to a neighbor radio network node, from measurement reports, and/or traffic related parameters. These features reflect characteristics, e.g., mobility speed, altitude etc. of the connected wireless device, thereby enabling a classification of the connected wireless devices.

Examples of the signal quality comprise Reference Signal Received Power (RSRP), SINR, Reference Signal Strength Indicator (RSSI), Reference Signal Received Quality (RSRQ) etc. Examples of the traffic related parameters comprise bit rate, variance in the traffic, etc. from the connected wireless devices. Examples of the mobility speed may comprise Doppler shift in a received signal.

According to an embodiment, if the wireless communication network has only aerial and terrestrial type devices, one single feature such as RSSI of the neighbor base stations would be enough for the classification. This is because that the elevated positions of the aerial type devices have near line of sight (LOS) link to the neighbor base stations, thus having higher RSRP values comparing to the serving base station. Alternatively, for the same scenario, it would be advantageous to extract more features. If multiple features such as RSRP of neighbor base stations and RSRP of the serving base station are extracted, the accuracy of the classification will be improved, since the RSRP of the serving base station is higher due to the higher probability of LOS link to the serving aerial type device. Which and how many features to be extracted is configurable.

Action S230. Upon the one or more features, the controller node 18 may classify the one or more wireless devices such as the wireless device 10 into different types. The types of the wireless devices may be configurable to meet different needs. The types of the wireless devices may comprise aerial type devices e.g., a drone, and territorial type devices such as land vehicles e.g. cars, etc. The territorial type device may further comprise vehicle and mobile station, etc.

Alternatively or additionally, the types of the wireless devices may comprise mobile station type devices and IoT type devices. The IoT type device may further comprise vehicles, non-movable devices, and aerial type devices.

Additionally or alternatively, the types of the wireless devices may comprise low bandwidth devices called narrow band devices such as energy meters, wearables, etc., high bandwidth and/or high power devices such as mobile-stations, drones, etc.

The controller node 18 may be configured with rules on classifying wireless devices into different types of the wireless device.

Alternatively, the controller node 18 may use a machine learning algorithm to learn and classify the types of wireless devices. Examples of the machine learning algorithm comprise algorithms based on supervised learning such as regression and its variants, unsupervised learning such as clustering and its variants, re-enforcement learning, etc. Advantages of employing machine learning algorithm comprise further improving the network performance. That is because the machine learning algorithm is able to arrive optimally at the non-linear relationship between the tunable network parameter and the device type ratio. Furthermore, employing machine learning algorithm may also bring an advantage of with dynamically determining the network parameters, due to the dynamic self-learning feature of the machine learning algorithm.

As an example of the machine learning algorithm, a multi-polynomial regression and stochastic gradient may be used to classify the wireless devices with more accuracy.

Upon the classification, a ratio of each type of wireless device may be calculated.

Action S240. The controller node 18 determines type information associated with wireless devices.

The type information may e.g., comprise ratios of different types of the wireless devices, such as 20% aerial, 10% vehicles and 70% mobile-stations.

Action S250. The controller node 18 determines the network parameter based on the type information. The controller node 18 may determine more than one network parameter, i.e., the controller node 18 may determine one or more network parameters based on the determined type information.

The network parameter comprises at least one of: an antenna related parameter associated with the radio network node 12, a handover parameter associated with the radio network node 12, a power related parameter associated with the wireless devices, and a scheduling parameter associated with the wireless devices.

Non-limiting examples of the above network parameters among others are provided herein:

Antenna related parameters
Antenna tilt angle
Beamforming parameters

Handover parameters
Hysteresis
Time-to-trigger (TTT)

Power related parameters
Open loop power control parameter (Pₒ)

Scheduling parameters
Quality of Service (QoS)
Admission control

For instance, in order to improve the throughput, signal quality and coverage, determining the network parameter refers to increasing the antenna tilt angle when less aerial type devices connected than before, and/or decreasing the antenna tilt angle in case of more aerial type devices connected than before.

Once the classification of various connected wireless devices is done, the tuning of the network may be accomplished based on the ratio R of different connected device types. Based on this ratio the network parameters θ may be tuned by solving an optimization problem with an objective. The optimization objective could be to maximize the sum throughput, reduce the net interference, improve the coverage, and/or the similar. Solving one or more optimization problems whenever the connected device type ratio changes may be costly in terms of computation and resources. Therefore, additionally or alternatively, an offline optimization technique may be used. I.e., parameter values θ₁, θ₂, etc. may be precomputed for device type ratios R₁, R₂, etc. respectively and stored in a look-up table. After that, the stored look-up table may be used to determine the network parameter values based on a closest ratio R.

As another object, in order to decrease interference, determining the network parameter may refer to lowering a transmit power of aerial devices in case of all or a major part of the connected wireless devices are of the aerial type, and increasing transmit power of mobile stations when all or a major part of the connected wireless devices are mobile station type devices.

The above described method in FIG. 2a may be performed periodically and/or upon a triggering event such as a handover event of a wireless device. An according advantage is to dynamically determine the network parameter along with the dynamic change of the type information.

FIG. 2b illustrates a detailed embodiment on determining the antenna tilt angle and TTT as examples of network parameters. TTT is a time during which specific criteria for an event needs to be met in order to trigger a handover. Values of the TTT may be 0, 40, 64, 80, 100, 128, 160, 256, 320, 480, 512, 640, 1024, 1280, 2560, and 5120 ms. For instance, when a received signal strength of a neighbor radio network node becomes better than that of the serving radio network node for a TTT value, e.g., 40 ms, the wireless device will handover from the serving radio network node to the neighbor radio network node after 40 ms.

In this embodiment, three example features F∈{F1, F2, F3}, are extracted from the connected wireless devices, which features are used by the controller node 18 to classify the wireless devices into different types. The features F1, F2, F3 indicate RSSI of serving radio network node, RSSI of the neighbor radio network node, and mobility speed respectively. For the reason of simplicity, the machine learning algorithm may be used as a non-limiting example herein to classify the wireless devices into types.

It is assumed that 100 wireless devices of three distinct types of wireless devices are connected in the wireless communication network, i.e. N=100 and T∈{Aerial, Vehicle, MobileStation}. Since high altitude aerial type devices have near line of sight (LoS) communication to multiple radio network nodes, e.g., base stations, the extracted features will have high RSSI values from neighbor and serving radio network nodes. A ground vehicular type device that has higher speed, may result in a doppler effect of a received signal, e.g., the RSSI, since a radio unit is inside a moving vehicle. Both mobile stations and vehicle type devices are on the ground, due to the obstacles in the terrain the neighbor cell signal may get attenuated, which significantly may result in low RSSI values for neighbor cells. A hyper-plane for classifying the types of wireless devices may be learnt by the machine learning algorithm. According to an embodiment a supervised machine learning method may be used. For instance, multi-polynomial regression and stochastic gradient may be applied on a training set of features to arrive at a supervised machine learning model. Such a trained machine learning model may subsequently be used on real-time features to classify the wireless devices with more accuracy.

As mentioned above, the machine learning algorithm may classify the N=100 wireless devices based on the features into one of the device types T. Upon the identified type, the ratios of types R may be calculated. For example, if the machine learning algorithm classifies N=100 wireless devices into 20 aerial, 10 vehicles and 70 mobile-stations, then determined ratios R=[20,10,70].

Based on this detected ratio R, the network parameters θ may be tuned by solving an optimization problem with an objective. For instance, let us consider improving a sum throughput [symbol] of the network as the objective and tunable network parameters θ=[α, Δ], where α is the antenna tilt angle and Δ is the TTT. Normally, a shorter TTT is optimal for high speed connections to avoid radio-link-failure. Given the ratio R, the choice of θ=[α, Δ] to maximize the sum throughput [symbol] will be posed as an optimization problem as below:

$${argmax}_{A . α} C \qquad ( 1 )$$

The values of [α, Δ] providing the maximum sum throughput will be determined as the values of the network parameter antenna tilt angle and TTT.

However solving the optimization problem whenever the connected device type ratio changes may be costly in terms of computation and resources. Therefore, additionally or alternatively, this optimization may be pre-computed for various ratios and maintained in a table. An example lookup table with precomputed parameter values is shown in Table 1.

TABLE 1

| R | α [deg] | Δ [ms] |
|---|---|---|
| R(1) = [0, 0, 100] | 45 | 100 |
| R(2) = [100, 0, 0] | 135 | 100 |
| R(3) = [0, 100, 0] | 45 | 50 |
| R(4) = [10, 20, 70] | 55 | 85 |
| . . . | . . . | . . . |

Both the total number X of entries included in the Table 1 and a value of each entry are configurable.

As shown above, when all the wireless devices are in aerial type, i.e., R(1)=[100,0,0], the antenna tilt angle α is 135 deg, i.e., the main lobe will be tilted upwards. On the other hand, when all the wireless devices are vehicles, the TTT value Δ is 50 ms. The TTT value is kept lower to avoid radio link failures.

Similarly, for any other ratios R, a closest entry in the Table 1 will be found to arrive at the optimal network parameter value θ to maximize the objective of sum throughput [symbol] . The closest entry in the Table 1 indicates the closeness in the detected ratio to the entries in the Table 1. For instance, this can be derived by choosing an entry in the Table 1 for which a Euclidian distance between the detected ratio R and the entry in the look-up table Table 1 is minimum as shown in the equation below.

$${argmin}_{i} ( {‖ R - R ( i ) ‖}_{2} ) \qquad ( 2 )$$

Where

i≤M,

argmin stands for argument of the minimum value,

∥.∥₂ represents an Lp norm.

Thus the maximum sum throughput is achieved by determining the network parameter based on the types of connected wireless devices.

In yet another detailed embodiment, determining the power related parameter, such as an open loop power control parameter will be discussed herein.

In a typical wireless communication network, the power control mechanism ensures that the transmit power of UEs are just enough so that the BS can demodulate the uplink data and at the same time the transmit power at UEs are not unnecessarily high as it could create interference to the other uplink transmissions. This can be accomplished through the power control mechanism.

The power control mechanism may normally include open loop and closed loop power control. In open loop power control, all of these inputs are from the wireless device's internal setting or measurement data by the wireless device 10. There is no feedback input from the radio network node 12. On the opposite, the closed loop power control also takes input from the radio network node 12 into account. Open loop power control is normally used to determine an initial transmission power, and the closed loop power control may adjust the transmission power dynamically and continuously during the connection. Open loop power control applies to both uplink, i.e., transmission power of the wireless device 10 and downlink, i.e., transmission power of the radio network node 12.

The open-loop power control mechanism is described through the equation below.

P_{PUSH}(i)=min{P_{CMAX}·Pₒ+γPL} (3)

### Where

P_{PUSH} (i) denotes power of an ith physical uplink shared channel
P_{CMAX} denotes the maximum UE transmit power in dBm
Pₒ denotes open loop power control parameter composed of cell specific parameter
P_{NOMINAL} and UE specific parameter P_{UE}
γ denotes the fractional path loss compensation and PL denotes the pathloss

It is assumed that the wireless communication network has only two types of wireless devices, i.e., T∈{Aerial,Terrestrial}. Once the device type ratio of wireless devices is detected, the cell specific parameter P_{NOMINAL} will be tuned to accomplish a particular objective, e.g., reducing a net interference in the cell Ω. The problem can be posed as an optimization problem as given below:

$$\text{?} Ω \\ \text{?} \text{indicates text missing or illegible when filed} \qquad ( 4 )$$

Additionally or alternatively, this optimization will be pre-computed for various ratios and maintained in a table. An example look-up table for power control optimization is shown in Table 2.

TABLE 2

| R | Ω[dBM] |
|---|---|
| R(1) = [0, 100] | −85 |
| R(2) = [100, 0] | −80 |
| R(3) = [50, 50] | −82 |
| . . . | . . . |

Both the total number Y of entries included in the Table 2 and a value of each entry are configurable.

Notice that when all the wireless devices are in aerial type ([100,0]), to make aerial type devices transmit at lower power since it creates interference to the neighbor cells, the nominal power P_{NOMINAL} will be decreased. Similarly, when all the wireless devices are terrestrial mobile stations ([0,100]), then the nominal power P_{NOMINAL} will be increased. The closest entry in the Table 2 to arrive at the optimal network parameter value S2 will be found by using the above function (2).

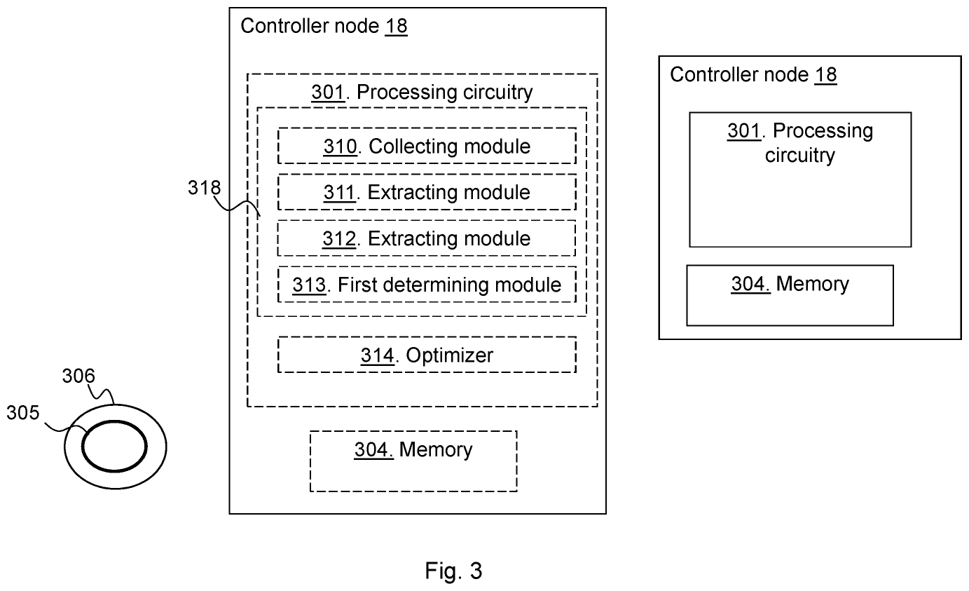

FIG. 3 is a block diagram depicting the controller node 18, e.g., for determining a network parameter, according to embodiments herein.

The controller node 18 may comprise processing circuitry 301, e.g. one or more processors, configured to perform the methods herein.

The controller node 18 may comprise a collecting module 310. The controller node 18, the processing circuitry 301, and/or the collecting module 310 may be configured to collect the data from the wireless devices.

The controller node 18 may comprise an extracting module 311. The controller node 18, the processing circuitry 301, and/or the extracting module 311 may be configured to extract one or more features associated with the wireless devices from the collected data.

The controller node 18 may comprise a classifying module 312. The controller node 18, the processing circuitry 301, and/or the classifying module 312 may be configured to classify the wireless devices into different types.

The controller node 18 comprises a first determining module 313. The controller node 18, the processing circuitry 301, and/or the first determining module 313 is configured to determine type information associated with wireless devices which are connected to the radio network node.

The controller node 18 comprises an optimizer 314, which may be also referred to as a second determining module. The controller node 18, the processing circuitry 301, and/or the optimizer 314 is configured to determine the network parameter based on the type information.

The above collecting module 310, extracting module 311, classifying module 312 and first determining module 313 together may be referred to as a classifying module 318. The classifying module 318 may be configured with rules on classifying wireless devices into different types. Alternatively, the classifying module 318 may run the machine learning algorithm which is able to learn the type information of wireless devices. In this case, classifying module 318 may be referred to as machine learning agent sometimes.

As mention above, the controller node 18 may be implemented either as a distributed node or a stand-alone node. For instance, some module, e.g., the classifying module 318, is deployed in cloud and the optimizer 314 is comprised in the radio network node 12, or all modulates of the controller node 18 are deployed in cloud. Advantage of implementing the classifying module 318 in cloud is that one classifying module 318 can be used for a plurality of radio network nodes in the radio access network, thereby optimizing the whole radio access network, e.g., improving its throughput in whole by using one single classifying module 318.

The controller node 18 may further comprise a memory 304. The memory comprises one or more units to be used to store data on, such as the inputs, outputs, thresholds, time period and/or the related parameters to perform the methods disclosed herein when being executed. Thus, the controller node 18 may comprise the processing circuitry 301 and the memory 304, said memory 304 comprising instructions executable by said processing circuitry 301 whereby said controller node 18 is operative to perform the methods herein.

The methods according to the embodiments described herein for the controller node 18 are respectively implemented by means of e.g. a computer program product 305 or a computer program, comprising instructions, i.e., software code portions, which, when executed on at least one processor, cause the at least one processor to carry out the actions described herein, as performed by the controller node 18. The computer program product 305 may be stored on a computer-readable storage medium 306, e.g. a disc, a universal serial bus (USB) stick or similar. The computer-readable storage medium 306, having stored thereon the computer program product 305, may comprise the instructions which, when executed on at least one processor, cause the at least one processor to carry out the actions described herein, as performed by the controller node 18. In some embodiments, the computer-readable storage medium may be a non-transitory computer-readable storage medium.

As will be readily understood by those familiar with communications design, that functions means or modules may be implemented using digital logic and/or one or more microcontroller nodes, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a controller node 18, for example.

Alternatively, several of the functional elements of the processing means discussed may be provided through the use of dedicated hardware, while others are provided with hardware for executing software, in association with the appropriate software or firmware. Thus, the term “processor” or “controller node” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of wireless devices will appreciate the cost, performance, and maintenance trade-offs inherent in these design choices.

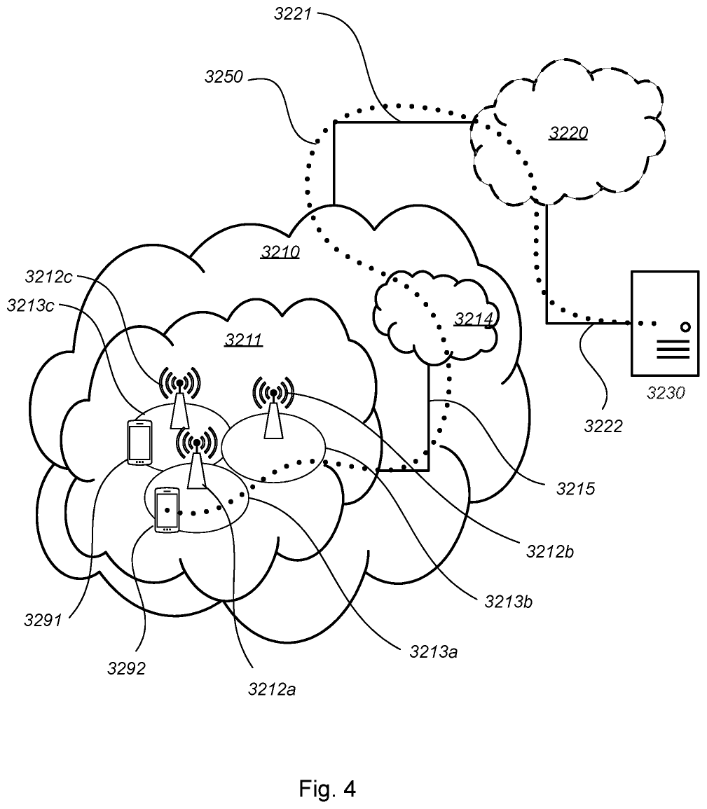

With reference to FIG. 4, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the radio network nodes herein, each defining a corresponding coverage area 3213a, 3213b, 3213c. Each base station 3212a, 3212b, 3212c is connectable to the core network 3214 over a wired or wireless connection 3215. A first user equipment (UE) 3291, being an example of the wireless device 10, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 4 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g. handed over) to a connected UE 3291. Similarly, the base station 3212 need not be aware of the future routing of an outgoing uplink communication originating from the UE 3291 towards the host computer 3230.

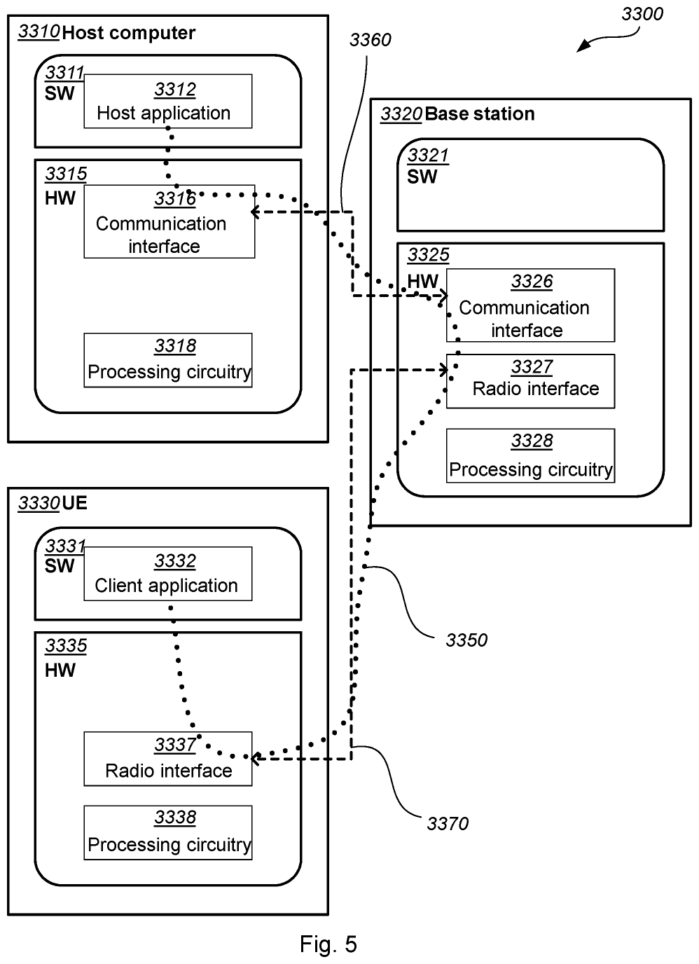

Example implementations, in accordance with an embodiment, of the UE, base station and host computer discussed in the preceding paragraphs will now be described with reference to FIG. 5. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 5) served by the base station 3320. The communication interface 3326 may be configured to facilitate a connection 3360 to the host computer 3310. The connection 3360 may be direct or it may pass through a core network (not shown in FIG. 5) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 5 may be identical to the host computer 3230, one of the base stations 3212a, 3212b, 3212c and one of the UEs 3291, 3292 of FIG. 4, respectively. This is to say, the inner workings of these entities may be as shown in FIG. 5 and independently, the surrounding network topology may be that of FIG. 4.

In FIG. 5, the OTT connection 3350 has been drawn abstractly to illustrate the communication between the host computer 3310 and the user equipment 3330 via the base station 3320, without explicit reference to any intermediary devices and the precise routing via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g. on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may have the advantage of improving overall network performance, such as the throughput, coverage, capacity and/or interference etc.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

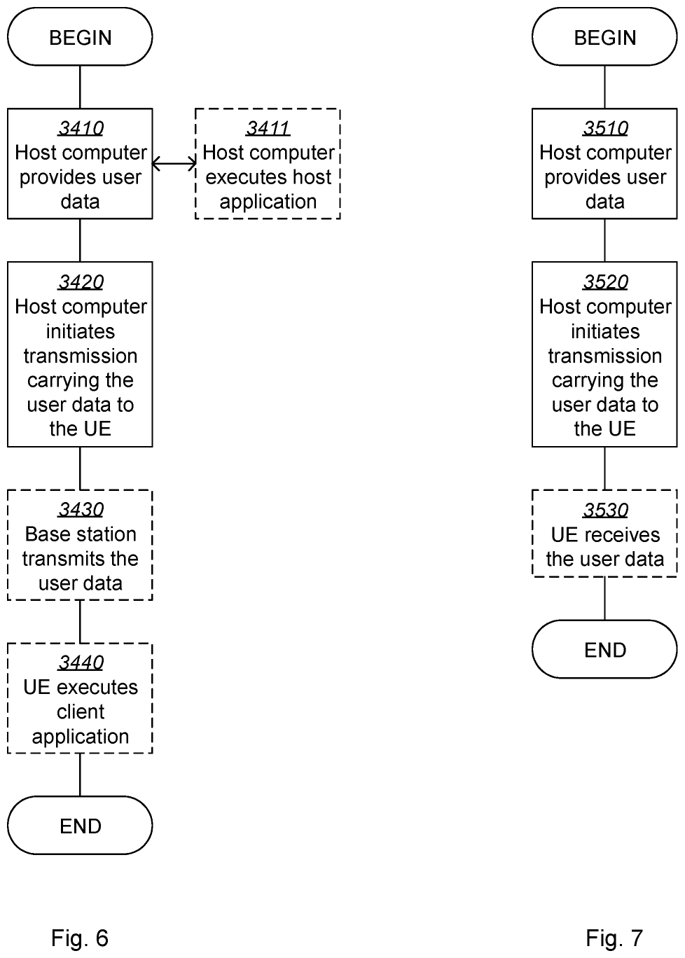

FIG. 6 is a flowchart illustrating a method implemented in a communication system, in accordance with one embodiment. The communication system includes a host computer, a base station and a UE which may be those described with reference to FIG. 4 and FIG. 5. For simplicity of the present disclosure, only drawing references to FIG. 6 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 7 is a flowchart illustrating a method implemented in a communication system, in accordance with one embodiment. The communication system includes a host computer, a base station and a UE which may be those described with reference to FIG. 4 and FIG. 5. For simplicity of the present disclosure, only drawing references to FIG. 7 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

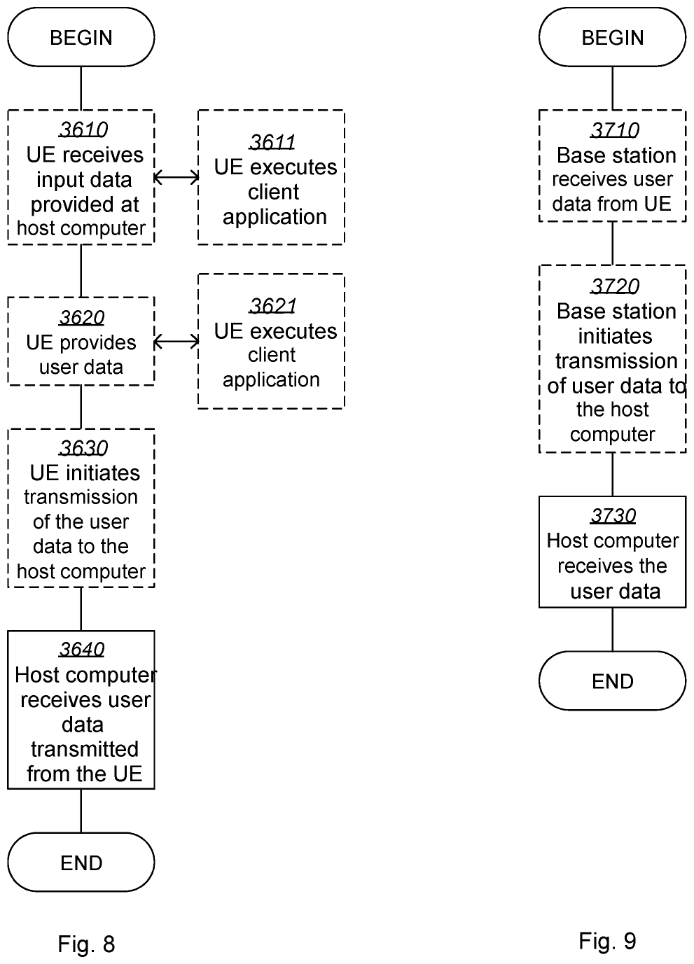

FIG. 8 is a flowchart illustrating a method implemented in a communication system, in accordance with one embodiment. The communication system includes a host computer, a base station and a UE which may be those described with reference to FIG. 4 and FIG. 5. For simplicity of the present disclosure, only drawing references to FIG. 8 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 9 is a flowchart illustrating a method implemented in a communication system, in accordance with one embodiment. The communication system includes a host computer, a base station and a UE which may be those described with reference to FIG. 4 and FIG. 5. For simplicity of the present disclosure, only drawing references to FIG. 9 will be included in this section. In an optional first step 3710 of the method, in accordance with the teachings of the embodiments described throughout this disclosure, the base station receives user data from the UE. In an optional second step 3711, the base station initiates transmission of the received user data to the host computer. In a third step 3730, the host computer receives the user data carried in the transmission initiated by the base station.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1-22. (canceled)

23. A method performed by a controller node, the method comprising the controller node:
determining type information associated with wireless devices which are connected to a radio network node; and
determining a network parameter based on the type information.

24. The method of claim 23, wherein the type information comprises ratios of different types of the wireless devices.

25. The method of claim 23, wherein the method is performed periodically and/or upon a triggering event.

26. The method of claim 23, further comprising classifying the wireless devices into different types based on one or more features associated with the wireless devices.

27. The method of claim 26, wherein the classifying of the wireless devices into different types is performed by using a machine learning algorithm.

28. The method of claim 24, wherein the different types of the wireless devices comprise at least two of: an aerial device, a vehicle, and a mobile station.

29. The method of claim 26, wherein the one or more features associated with the wireless devices are indicated by: a mobility speed of the wireless device, a signal quality from the wireless device to the radio network node, a signal quality from the wireless device to a neighbor radio network node, and/or other traffic related parameters.

30. The method of claim 26, further comprising extracting the features associated with the wireless devices from data collected from the wireless devices.

31. The method of claim 23, wherein the network parameter comprises: an antenna related parameter associated with the radio network node, a handover parameter associated with the radio network node, a power related parameter associated with the wireless devices, and/or a scheduling parameter associated with the wireless devices.

32. A controller node, comprising:
processing circuitry;
memory containing instructions executable by the processing circuitry whereby the controller node is operative to:
determine type information associated with wireless devices which are connected to a radio network node; and
determine a network parameter based on the type information.

33. The controller node of claim 32, wherein the type information comprises ratios of different types of the wireless devices.

34. The controller node of claim 32, wherein the instructions are such that the controller node is operative to determine the network parameter periodically and/or upon a triggering event.

35. The controller node of claim 32, wherein the instructions are such that the controller node is operative to classify the wireless devices into different types based on one or more features associated with the wireless devices.

36. The method of claim 35, wherein the instructions are such that the controller node is operative to classify the wireless devices into different types by using a machine learning algorithm.

37. The controller node of claim 33, wherein the different types of the wireless devices comprise at least two of: an aerial device, a vehicle, and a mobile station.

38. The controller node of claim 35, wherein the one or more features associated with the wireless devices are indicated by: a mobility speed of the wireless device, a signal quality from the wireless device to the radio network node, a signal quality from the wireless device to a neighbor radio network node, and/or other traffic related parameters.

39. The controller node of claim 35, wherein the instructions are such that the controller node is operative to extract the features associated with the wireless devices from data collected from the wireless devices.

40. The controller node of claim 32, wherein the network parameter comprises: an antenna related parameter associated with the radio network node, a handover parameter associated with the radio network node, a power related parameter associated with the wireless devices, and/or a scheduling parameter associated with the wireless devices.

41. The controller node of claim 32, wherein the controller node is a distributed node or a stand-alone node.

42. A non-transitory computer readable recording medium storing a computer program product for controlling a controller node, the computer program product comprising program instructions which, when run on processing circuitry of the controller node, causes the controller node to:
determine type information associated with wireless devices which are connected to a radio network node; and
determine a network parameter based on the type information.
